(19) United States
(12) Patent Application Publication
(10) Pub. No.: US 2019/0324560 A1
(43) Pub. Date: Oct. 24, 2019

(54) ELECTRONIC STYLUS PEN

(71) Applicant: Jamie Wilson-Haynes, Columbia, TN (US)

(72) Inventor: Jamie Wilson-Haynes, Columbia, TN (US)

(21) Appl. No.: 15/961,340

(22) Filed: Apr. 24, 2018

(51) Int. Cl. G06F 3/0354; G06T 1/00; G06F 17/30

(52) U.S. Cl. CPC G06F 3/03545; G06F 17/3028; G06T 1/0007

(57) ABSTRACT

A stylus pen, and a method of using the same, that includes: a storage database; a copy mechanism, where the copy mechanism copies images and data from the first electronic device and stores data onto the storage database; and a paste mechanism where the paste mechanism places images and data stored on the storage database transfers the images and data to a second electronic device.

### BACKGROUND OF THE INVENTION

### Field of Invention

The purpose of the invention is interact with a touch screen with an electronic device that includes memory and storage capabilities.

### Description of Related Art

Many electronic devices in use today include touch screen interactivity. A touch screen allows an individual to use their finger or in some cases a stylus to activate and engage the information and data on the screen during use. These touch screens are commonly used on small smartphones and electronic tablets. Many people have multiple electronic devices with touch screens such as a smartphone and a tablet, where they may engage interactively sometimes simultaneously. For example, one may be working on a smartphone and come across information that one may desire to transfer for further manipulation on a tablet or laptop computer. Currently, there are limited options for copying and pasting information or data to transfer the information or data to a separate electronic device. As a consequence, it would be advantageous to have an interactive stylus pen that's capable of copying and pasting information and data between electronic devices.

### SUMMARY OF THE INVENTION

The present invention relates to a stylus pen that includes: a storage database; a copy mechanism, where the copy mechanism copies images and data from the first electronic device and stores data onto the storage database; and a paste mechanism where the paste mechanism places images and data stored on the storage database transfers the images and data to a second electronic device.

### BRIEF DESCRIPTION OF DRAWINGS

FIG. 1 depicts a stylus pen in accordance with the present invention.

### DETAILED DESCRIPTION

The present invention relates to a device and method of transferring information and data from a first electronic device to a second electronic device. The present invention contemplates use of a stylus pen for interactive use with a touch screen on an electronic device. The stylus pen according to the present invention is capable of electronically copying images and data from a first electronic device and then storing that image and data in temporary storage within the stylus pen for a transfer to a second electronic device. A scanner or camera within stylus pen, while the stylus pen is able for use on a touch screen. An application is provide for the electronic device to provide a means to transfer images to the electronic device.

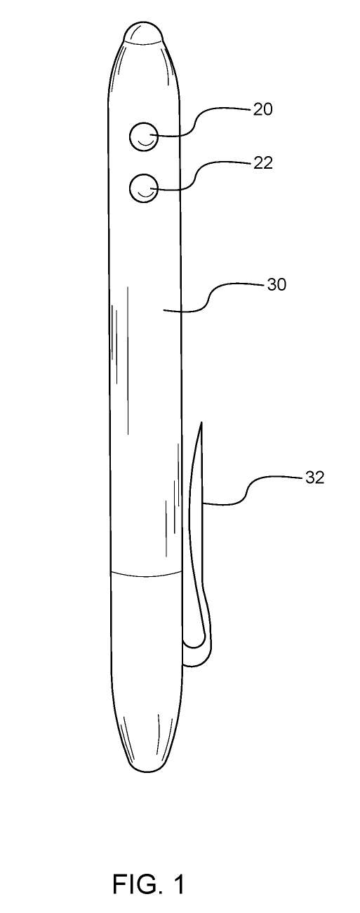

FIG. 1 depicts a stylus pen 30 in accordance with the present invention. The stylus pen 30 includes a clip 32 for placement in a shirt pocket or otherwise. Generally, the stylus pen 30 includes a storage database that is adapted for storing information and data while contacting a touch screen of an electronic device. The stylus pen 30 includes the temporary storage database, which stores data through activation by a copy button 20 on the stylus pen 30. The stylus pen 30 includes mechanisms that copy the contents shown on the first electronic device and stores it in a database, preferably a camera is provided in the stylus pen 30 that photographs images on the first electronic device for transfer to a second electronic device. A paste button 22 is provided which allows a user to transfer from the storage database stored information and data onto a second electronic device.

The use of the stylus pen 30 assists in the transfer of information and data between electronic devices. As a result, the present invention creates a method of transfer of information and data including use of the stylus pen by executing steps in accordance with the functions stated above. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A stylus pen comprising:
a storage database;
a copy mechanism, where the copy mechanism copies images and data from the first electronic device and stores data onto the storage database; and
a paste mechanism where the paste mechanism places images and data stored on the storage database transfers the images and data to a second electronic device.

2. A method of transferring images or data using a stylus pen comprising the steps of:
contacting a touchscreen of a first electronic device with the stylus pen;
activating a copy mechanism on the stylus pen;
copying images or data on the first electronic device via the copy mechanism;
storing the images or data on a database residing in the stylus pen; and
transferring the stored images or data onto a second electronic device by activating a paste mechanism on the stylus pen.
